(19) United States
(12) Patent Application Publication
(10) Pub. No.: US 2019/0070807 A1
(43) Pub. Date: Mar. 7, 2019

(54) SYSTEMS, DEVICES, AND METHODS FOR MANUFACTURING AN EYEGLASS LENS

(71) Applicant: THALMIC LABS INC., Kitchener (CA)

(72) Inventor: Darren Ihmels, Toronto (CA)

(21) Appl. No.: 16/119,515

(22) Filed: Aug. 31, 2018

Related U.S. Application Data
(60) Provisional application No. 62/553,544, filed on Sep. 1, 2017.

(51) Int. Cl. B29D 11/00; G02C 7/02; G02B 27/10; G02B 5/32

(52) U.S. Cl. CPC B29D 11/00942; G02C 7/02; G02B 27/1086; B24B 9/14; B29D 11/0048; B29D 11/00865; G02B 5/32

(57) ABSTRACT

A provisional lens structure has a grip tab region that allows the provisional lens structure to be supported and maneuvered, for example during subsequent manufacturing operations to produce a finished lens, thereby reducing the risk of damage to the provisional lens structure as compared to conventional approaches in which the provisional lens is supported and maneuvered directly by the edge of the provisional lens.

### TECHNICAL FIELD

The present systems, devices, and methods generally relate to manufacturing an eyeglass lens and particularly relate to manufacturing an eyeglass lens by processing a partially manufactured lens via a clip.

### BACKGROUND

### Description of the Related Art

### Eyeglass Lenses

Eyeglass lenses are objects made of a transparent lens material, typically glass or plastic, that can be mounted in eyeglass lens frames. Eyeglass lenses may be converging, diverging lenses, or plano. Converging and diverging lenses may provide vision correction as prescribed by an optometrist. Plano lenses may provide light blocking, as in sunglasses, or they may be worn solely for their aesthetic appeal.

The glass or plastic lens material may be scratched if the lens is dropped on the ground or brought into contact with a sharp or hard surface. Scratches to the lens cause often irreparable damage to the eyeglass lens, reducing the aesthetic appeal of the lens and rendering the eyeglass lens unusable if the damage is sufficiently severe. Scratch-resistant coatings may be applied to the eyeglass lens to reduce or prevent damage to the eyeglass lens, however the lenses may be damaged during manufacturing before or during application of the scratch-resistant coating.

### BRIEF SUMMARY

An eyeglass lens blank may be summarized as including: a single continuous piece of lens material, the single continuous piece of lens material may include: a provisional optical element region having a periphery, where the provisional optical element region may have a size greater than an eyeglass lens in all dimensions; and a grip tab region may be comprised of sacrificial lens material, wherein the grip tab region may be positioned at the periphery of the provisional optical element region, the grip tab region may extend beyond the periphery of the provisional optical element region, and where the grip tab region may be sized and dimensioned to interface with a clip.

The grip tab region may extend outward from the optical element region in a direction perpendicular to a principal axis of the optical element region. The grip tab region may extend outward from the optical element region symmetrically in all directions perpendicular to the principal axis of the optical element region. The grip tab region may extend outward from the optical element region asymmetrically in at least one direction perpendicular to the principal axis of the optical element region. The optical element region may include a diffractive element embedded within an inner volume thereof. The diffractive element may include photopolymer. The diffractive element may include a hologram. The hologram may include a wavelength-multiplexed hologram.

A provisional lens structure for processing into a finished lens may be summarized as including: a single continuous piece of lens material, the single continuous piece of lens material may include: an optical element region having a periphery, where the optical element region may have a size greater than an eyeglass lens in at least two dimensions; and a grip tab region may be comprised of sacrificial lens material, wherein the grip tab region may be positioned at the periphery of the optical element region, and where the grip tab region may be sized and dimensioned to interface with a clip.

The grip tab region may extend outward from the optical element region in a direction perpendicular to a principal axis of the optical element region. The grip tab region may extend outward from the optical element region symmetrically in all directions perpendicular to the principal axis of the optical element region. The grip tab region may extend outward from the optical element region asymmetrically in at least one direction perpendicular to the principal axis of the optical element region. The optical element region may include a diffractive element embedded within an inner volume thereof. The diffractive element may include photopolymer. The diffractive element may include a hologram. The hologram may include a wavelength-multiplexed hologram. The optical element region may include a lens, where the lens may have a refractive power chosen from a range of −20 to +20 diopters.

A method of fabricating an eyeglass lens may be summarized as including: forming a provisional lens structure, wherein forming the provisional lens structure may include shaping a single continuous piece of lens material to define: an optical element region having a periphery; and a grip tab region comprised of sacrificial lens material, where the grip tab region may be positioned at the periphery of the optical element region, and where the grip tab region may be sized and dimensioned to interface with a clip; attaching the clip to the grip tab region of the provisional lens structure; processing the provisional lens structure, wherein processing the provisional lens structure may include supporting and maneuvering the provisional lens structure via the clip; removing the clip from the grip tab region of the provisional lens structure; and edging the provisional lens structure to produce the eyeglass lens, wherein edging the provisional lens structure may include removing the grip tab region from the provisional lens structure.

Supporting and maneuvering the provisional lens structure via the clip may include at least one maneuver selected from a group consisting of: raising the provisional lens structure via the clip, lowering the provisional lens structure via the clip, rotating the provisional lens structure via the clip, and displacing the provisional lens structure via the clip. Processing the provisional lens structure may include applying at least one coating to the provisional lens structure while supporting and maneuvering the provisional lens structure via the clip.

Processing the provisional lens structure may further include: physically coupling the clip to a mechanical arm; while supporting and maneuvering the provisional lens structure via the clip: lowering the provisional lens structure into a liquid coating material by the mechanical arm; and raising the provisional lens structure out of the liquid coating material by the mechanical arm, wherein a portion of the liquid coating material may remain physically coupled to the provisional lens structure after the provisional lens structure is raised out of the liquid coating material by the mechanical arm; curing the portion of liquid coating material that remains physically coupled to the provisional lens structure; and physically de-coupling the clip from the mechanical arm.

Processing the provisional lens structure may further include: physically coupling the clip to a calotte; while supporting and maneuvering the provisional lens structure via the clip: placing the provisional lens structure in a vacuum chamber by the calotte; removing air from the vacuum chamber; depositing a first amount of AR material on a first surface of the optical element region; rotating the unfinished lens via the clip; depositing a second amount of AR material on a second surface of the optical element region; filling the vacuum chamber with air; removing the provisional lens structure from the vacuum chamber by the calotte; and physically de-coupling the clip from the calotte.

Forming a provisional lens structure may include: filling a mold with a resin, wherein the mold may include an internal cavity that defines the optical element region and the grip tab region of the provisional lens structure; curing the resin to produce the provisional lens structure; and removing the provisional lens structure from the mold. Forming a provisional lens structure may further include mounting a diffractive element in the mold prior to filling the mold with the resin. Forming a provisional lens structure may include forming a provisional lens structure with an optical element region in the shape of a lens, where the lens may have a refractive power chosen from a range of −20 to +20 diopters. Attaching the clip to the grip tab region of the provisional lens structure may include attaching the clip to the grip tab region of the provisional lens structure with a mechanical locking feature.

Attaching the clip to the grip tab region of the provisional lens structure may include at least one process selected from a group consisting of: adhering the clip to the grip tab region of the provisional lens structure with adhesive, welding the clip to the grip tab region of the provisional lens structure, bonding the clip to the grip tab region of the provisional lens structure with a mechanical locking feature, and bonding the clip to the grip tab region with fastening hardware. Edging the provisional lens structure to produce the eyeglass lens may further include: removing at least a portion of the optical element region to provide the optical element region with a general shape and appearance of an eyeglass lens.

Forming a provisional lens structure may include forming a provisional lens structure wherein the grip tab region extends outward from the optical element region in a direction perpendicular to a principal axis of the optical element region. Forming a provisional lens structure may include forming a provisional lens structure wherein the grip tab region extends outward from the optical element region symmetrically in all directions perpendicular to the principal axis of the optical element region. Forming a provisional lens structure may include forming a provisional lens structure wherein the grip tab region extends outward from the optical element region asymmetrically in at least one direction perpendicular to the principal axis of the optical element region. Forming a provisional lens structure may include forming a provisional lens structure wherein the optical element region may include a diffractive element embedded within an inner volume thereof. Forming a provisional lens structure may include forming a provisional lens structure wherein the diffractive element comprises photopolymer. Forming a provisional lens structure may include forming a provisional lens structure wherein the diffractive element comprises a hologram. Forming a provisional lens structure may include forming a provisional lens structure wherein the hologram comprises a wavelength-multiplexed hologram.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the particular shapes of the elements as drawn are not necessarily intended to convey any information regarding the actual shape of the particular elements, and have been solely selected for ease of recognition in the drawings.

FIG. 1 is a front elevational view of a conventional provisional lens processing assembly 100.

FIG. 2A is a front elevational view of eyeglass lens blank with a grip tab in accordance with a first implementation of the present systems, devices, and methods.

FIG. 2B is a front elevational view of an eyeglass lens blank with a grip tab in accordance with a second implementation the present systems, devices, and methods.

FIG. 3A is a side elevational view of a provisional lens structure in accordance with the present systems, devices, and methods.

FIG. 3B is a front elevational view the provisional lens structure of FIG. 3A.

FIG. 3C is a side elevational view of an eyeglass lens blank in accordance with the present systems, devices, and methods.

FIG. 3D is a front elevational view of the eyeglass lens blank of FIG. 3C.

FIG. 4 is a flow diagram showing a method of fabricating an eyeglass lens in accordance with the present systems, devices, and methods.

FIG. 5 is a schematic view of provisional lens structure dip-coating assembly 500 in accordance with the present systems, devices, and methods.

FIG. 6 is a schematic view of provisional lens structure AR-coating assembly 600 in accordance with the present systems, devices, and methods.

FIG. 7 is a cross-sectional view of provisional lens structure forming mold 700 in accordance with the present systems, devices, and methods.

FIG. 8A is a front elevational view of mechanically locked assembly 800a in accordance with the present systems, devices, and methods.

FIG. 8B is a front elevational view of mechanically fastened assembly 800b in accordance with the present systems, devices, and methods.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with lens, blanks, and portable electronic devices and head-worn devices that employ lenses, have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The headings and Abstract of the Disclosure provided herein are for convenience only and do not interpret the scope or meaning of the embodiments.

The various embodiments described herein provide systems, devices, and methods for manufacturing an eyeglass lens and are particularly well-suited for use in ophthalmic laboratories.

Fabricating an eyeglass lens may include forming, polishing, coating, and edging a partially manufactured lens to produce a fully manufactured eyeglass lens. Throughout this specification and the appended claims, the term “fully manufactured lens” generally refers to a lens that has been formed, polished, coated, and edged according to the specifications of a user. An eyeglass lens is a non-exclusive example of a fully manufactured lens. Forming a partially manufactured lens includes shaping a single piece of lens material to produce a partially manufactured lens of approximately the specified thickness and curvature. Throughout this specification and the appended claims, the term “lens material” generally refers to a material that is transparent at least to light in the visible portion of the electromagnetic spectrum and strong enough to be safely used to manufacture eyeglass lenses according to ANSI ASC Z80 standards. Polishing a partially manufactured lens includes smoothing the partially manufactured lens and, if necessary, shaping the partially manufactured lens to the exact thickness and curvature specified by the user. Polishing the partially manufactured lens improves the optical transmittance and resolving power of the lens. Coating the partially manufactured lens includes applying at least one coating material to the surface of the partially manufactured lens. Non-exclusive examples of functions performed by coating materials include reducing reflections, blocking Ultraviolet (UV) light, blocking blue light, and blocking a portion of light across the entire visible spectrum. Edging a partially manufactured lens includes shaping the edges of the partially manufactured lens to produce a fully manufactured lens with a shape that fits inside an eyeglass lens frame such that the fully manufactured lens is physically coupleable to the eyeglass lens frame.

Throughout this specification and the appended claims, the term “partially manufactured lens” generally refers to an eyeglass lens that, to meet the specifications of the user, requires at least one of the following: forming, polishing, coating, and edging. Non-exclusive examples of partially manufactured lenses include an eyeglass lens blank and a provisional lens.

Throughout this specification and the appended claims, the term “eyeglass lens blank” generally refers to a partially manufactured lens that requires forming; an eyeglass lens blank may also require polishing, coating, and edging. An eyeglass lens blank typically possesses a first blank surface that has been formed and polished and a second blank surface that has neither been formed nor polished. The second blank surface may be formed and polished during fabrication of a fully manufactured lens. Fabricating a fully manufactured lens from an eyeglass lens blank is advantageous because the unfinished nature of the second blank surface allows the possibility of shaping an eyeglass lens blank into a variety of curvatures according to the specifications of a user, while the first blank surface reduces the time needed to manufacture the lens since there is no need to additionally shape or polish the first surface. Throughout this specification and the appended claims, the term “provisional lens” generally refers to a partially manufactured lens which possesses at least approximately the specified shape and thickness according to the specifications of a user; a provisional lens may require polishing, coating, and edging.

Edging the partially manufactured lens typically includes blocking the partially manufactured lens. Blocking the partially manufactured lens includes attaching a blocking body to the surface of a partially manufactured lens with a blocking adhesive; the partially manufactured lens is then physically coupled to the edging machine via the blocking body. Typical blocking adhesives include UV-curable adhesives and metal alloys with a melting point in the range of 117° F. to 158° F. Blocking adhesives typically have low bonding strength to ensure that the blocking adhesive does not damage the finished surface of the partially manufactured lens when the blocking adhesive is removed.

The forming, polishing, coating, and edging of partially manufactured lenses during fabrication to create fully manufactured lenses are typically performed in different machines or locations, requiring the repeated transportation, mounting, and dismounting of the partially manufactured lens. Partially manufactured lenses are typically round or oval when viewed along their principal axis. Throughout this specification and the appended claims, the term “principal axis” generally refers to the line passing through the optical center and optical centers of curvature of the faces of a lens. The round shape of a partially manufactured lens makes the partially manufactured lens difficult to transport, mount, and dismount, as the partially manufactured lens must be gripped to do so, and any point of the partially manufactured lens that is gripped is a surface of the partially manufactured lens that is easily damaged.

The attachment of a blocking body to the surface of a partially manufactured lens prior to edging allows the lens to be gripped during edging with a reduced risk of damage to the lens, however the blocking body obstructs the surface of the partially manufactured lens and thus cannot be used during coating or polishing of the partially manufactured lens. A clip may be attached to a partially manufactured lens to allow processing of the partially manufactured lens, including coating of the partially manufactured lens. It is typically preferred that the physical coupling between the partially manufactured lens and the contact point(s) of the clip be strong to prevent the partially manufactured lens from unintentionally detaching from the clip during processing of the partially manufactured lens. Strong physical coupling between the partially manufactured lens and the clip may be achieved by placing the contact point(s) of the clip in compression, however if a contact point detaches unintentionally from the partially manufactured lens during physical coupling or physical de-coupling of the lens and the clip, the clip will typically scratch the partially manufactured lens, causing irreparable damage to the partially manufactured lens.

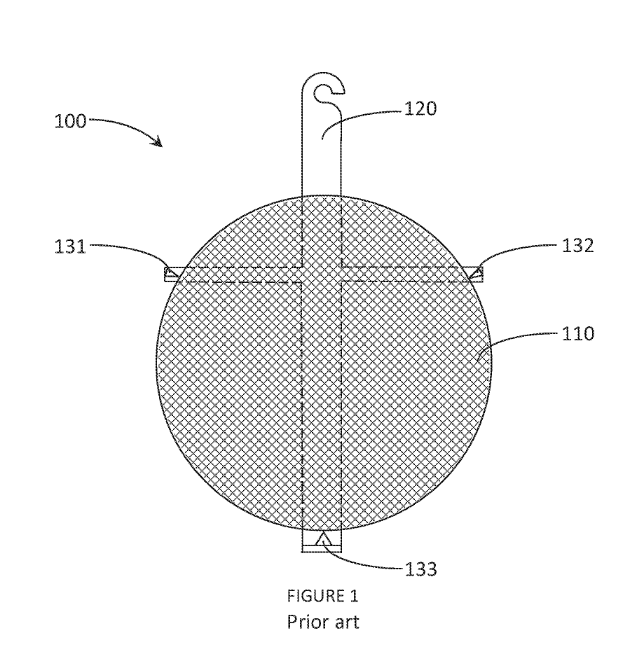

FIG. 1 is front elevational view of a conventional provisional lens processing assembly 100. Provisional lens processing assembly 100 includes the provisional lens 110 and clip 120. Clip 120 includes contact point 131, contact point 132, contact point 133. Provisional lens 110 is physically coupled to clip 120 by contact point 131, contact point 132, and contact point 133.

Processing provisional lens 110 includes supporting and maneuvering provisional lens 110 via the clip. Supporting and maneuvering provisional lens 110 via the clip includes at least one maneuver selected from a group consisting of: raising provisional lens 110 via clip 120, lowering provisional lens 110 via clip 120, rotating provisional lens 110 via clip 120, displacing provisional lens 110 via clip 120, or otherwise using clip 120 to position and/or orient provisional lens 110 with respect to some external reference point. The physical coupling between clip 120 and provisional lens 110 causes any maneuvering of clip 120 to also maneuver provisional lens structure 110.

Provisional lens processing assembly 100 may be constructed by physically coupling contact point 131, contact point 132, and contact point 133 to provisional lens 110. Processing of provisional lens 110 without clip 120 may cause accidental damage to provisional lens 110. Non-exclusive examples of events that cause damage to provisional lens 110 include dropping provisional lens 110 while transporting provisional lens 110 from one place to another, and misalignment of provisional lens 110 during the mounting of provisional lens 110 into a bracket, causing direct physical contact between the bracket and provisional lens 110 with subsequent scratching of provisional lens 110.

Throughout this specification and the appended claims, the term “bracket” generally refers to a first component or support where the first component or support is physically coupleable to a second component and where the first component may also be physically coupleable to a third component. The bracket may enable the physical coupling of the second component to the third component via the bracket. The bracket may improve the physical coupling of the second component to the third component, non-exclusive examples of improved physical couplings include a physical coupling that is stronger and a physical coupling that is easier to create or break compared to a physical coupling without a bracket. Non-exclusive examples of components into which a provisional lens may be mounted via a bracket include a vacuum-deposition calotte and a CNC mill chuck.

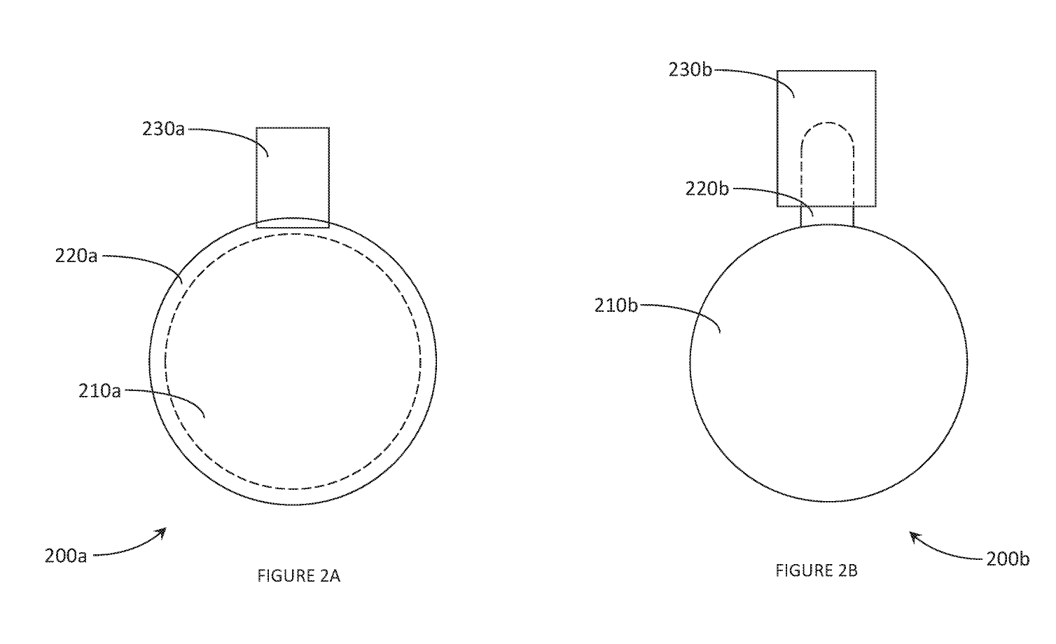

FIG. 2A is a front elevational view of eyeglass lens blank with a grip tab 200a in accordance with a first implementation of the present systems, devices, and methods. Eyeglass lens blank 200a is comprised of a single continuous piece of lens material. Eyeglass lens blank 200a is comprised of provisional optical element region 210a and grip tab region 220a. The grip tab 220a may be integral, and even a unitary single piece construction, with the optical element region 210a. Provisional optical element region 210a has a periphery and a size greater than an eyeglass lens in all dimensions.

Grip tab region 220a is positioned at the periphery of provisional optical element region 210a. Grip tab region 220a extends beyond the periphery of provisional optical element region 210a. Grip tab region 220a is sized and dimensioned to interface with clip 230a. Grip tab region 220a is comprised of sacrificial lens material. All sacrificial lens material is removed from eyeglass lens blank 200a when eyeglass lens blank 200a is processed to produce an eyeglass lens. Sacrificial lens material may comprise lens material that is substantively similar to the lens material comprising optical element region 210a. Sacrificial lens material may be of a shape that is at least partially incompatible with processing. Non-exclusive examples of shapes that are incompatible with processing include structural lens material that is inaccessible to the polishing head of a CNC mill machine, and structural lens material that is covered by a clip and inaccessible to coating, shaping, and polishing. Processing incompatibilities of the structural lens material will cause the structural lens material to possess optical properties that do not meet the specifications for the optical grade lens material, however this will not affect the optical properties of an eyeglass lens fabricated using eyeglass lens blank 200a since none of the structural lens material will be present in a fully manufactured eyeglass lens produced from eyeglass lens blank 200a. Clip 230a may be physically coupled to grip tab region 220a, in which case eyeglass lens blank 200a may be processed by supporting and maneuvering eyeglass lens blank 200a via clip 230a.

Processing eyeglass lens blank 200a via clip 230a at least reduces the risk of damage to provisional optical element region 210a. If clip 230a were physically coupled to provisional optical element area 210a then clip 230a may damage provisional optical element area 210a; physically coupling clip 230a to grip tab region 220a at least reduces the risk of damage to provisional optical element region 210a by clip 230a. Damage to any portion of provisional optical element region 210a, including the periphery of provisional optical element region 210a, may render eyeglass lens blank 200a unusable for manufacturing eyeglass lenses due to overlap between the damaged area and the area of the eyeglass lens.

Physically coupling clip 230a to grip tab region 220a is particularly advantageous because grip tab region 220a may possess features (e.g. surface roughness, raised or depressed features) that reduce the optical performance of grip tab region 220a but improve physical coupling between grip tab region 220a and clip 230a; a reduction in optical performance of sacrificial lens material is irrelevant to the performance of a fully manufactured lens. Grip tab region 220a may be sized and dimensioned to a standard thickness. Across a series of eyeglass lens blanks, the thickness of the optical element region of the eyeglass lens blanks vary significantly to allow for variety in the shape of the fully manufactured lenses produced from the eyeglass lens blanks. Thickness variation in the periphery of eyeglass lens blanks used to produce prescription eyeglass lenses is particularly common due to the drastic differences in edge thickness when comparing converging and diverging lenses. A grip tab region with a standard thickness allows the use of a standardized clip across a series of eyeglass lens blanks for producing prescription eyeglass lenses of varying focusing power. The use of a standardized clip is particularly advantageous as it allows greater automation of eyeglass lens manufacture.

Grip tab region 220a may extend outward from provisional optical element region 210a in a direction perpendicular to a principal axis of provisional optical element region 210a. A grip tab region that extends perpendicular to the principal axis of provisional optical element region 210a is less likely to interfere with the free movement of the cutting head of a CNC mill when forming eyeglass lens blank 200a into a provisional lens structure. Grip tab region 220a may extend outward from provisional optical element region, for example extending circumferentially outward from the periphery of the optical element region 210a in all directions perpendicular to the principal axis of provisional optical element region 210a. The grip tab region 220a may be integral, and even a unitary single piece construction, with the optical element region 210a. While shown as a rim extending completely around or symmetrically surrounding the periphery of the optical element region 210a, in some implementations the grip tab region 220a may extend only partially around or only partially surrounding the periphery of the optical element region 210a, for instance circumscribing one arc or two or more arcs. Eyeglass lens blank 200a may be produced from a pre-blank by a CNC mill where the pre-plank rotates and the cutting head of the CNC mill remains stationary.

A diffractive element may be embedded within an inner volume of provisional optical element region 210a. A diffractive element is an optical element that is comprised of a series of ridges or fringes that form an optical element by diffracting light. Non-limiting examples of diffractive elements include a hologram, a holographic optical element, a volume diffraction grating, a surface relief diffraction grating, a transmission grating, or a reflection grating. Additional functionality may be imparted to an eyeglass lens by embedding a diffractive element in the eyeglass lens. The additional functionality provided by the diffractive element may, for example, enable the eyeglass lens to be used in advanced optical devices, including performing the role of transparent optical combiner in a wearable heads-up display (WHUD) and smart glasses.

If the diffractive element is a hologram, the diffractive element may comprise photopolymer material. If the diffractive element is a hologram, the diffractive element may comprise a wavelength multiplexed hologram. A wavelength multiplexed hologram comprises at least two wavelength-specific holograms, wherein each wavelength-specific hologram possesses a respective playback wavelength. A wavelength multiplexed hologram may include a red hologram, a green hologram, and a blue hologram.

In some implementations, the diffractive element may be carried on or by another structure. For instance, one or more diffractive elements may be carried on or by a waveguide or lightguide structure and may serve as, for example, an in-coupler or out-coupler for such waveguide or lightguide structure. In such implementations, at least a portion (or an entirety) of the waveguide or lightguide structure may be embedded within an inner volume of provisional optical element region 210a. Thus, for the purposes of the present systems, device, and methods, including the appended claims, the term “diffractive element” includes a diffractive material combined with waveguide/lightguide structures. Likewise, when the term “diffractive element” is used, the diffractive element may be carried on or by other structures or layers, or may itself carry other structures or layers, depending on the specific implementation.

FIG. 2B is a front elevational view of eyeglass lens blank with a grip tab 200b in accordance with a second implementation of the present systems, devices, and methods. Eyeglass lens blank 200b is similar in some respects to eyeglass lens blank 200a. Eyeglass lens blank 200b is comprised of a single continuous piece of lens material. Eyeglass lens blank 200b is comprised of provisional optical element region 210b and grip tab region 220b. The grip tab 220b may be integral, and even a unitary single piece construction, with the optical element region 210b. Provisional optical element region 210b has a periphery and a size greater than an eyeglass lens in all dimensions.

Grip tab region 220b is positioned at the periphery of provisional optical element region 210b. Grip tab region 220b extends beyond the periphery of provisional optical element region 210b. Grip tab region 220b is sized and dimensioned to interface with clip 230b. Grip tab region 220b is comprised of sacrificial lens material. All sacrificial lens material is removed from eyeglass lens blank 200b when eyeglass lens blank 200b is processed to produce an eyeglass lens. Clip 230b may be physically coupled to grip tab region 220b, in which case eyeglass lens blank 200b may be processed by supporting and maneuvering eyeglass lens blank 200b via clip 230b.

Grip tab region 220b may extend radially outward from provisional optical element region 210b in a direction perpendicular to a principal axis of provisional optical element region 210b. Grip tab region 220b may extend outward from element region 210b asymmetrically with respect to the principal axis, in at least one direction perpendicular to the principal axis of element region 210b. The grip tab region 220b may be integral, and even a unitary single piece construction, with the optical element region 210b. Eyeglass lens blank 200b may be produced from a pre-blank by a CNC mill where the cutting head of the CNC mill rotates and the pre-blank remains stationary.

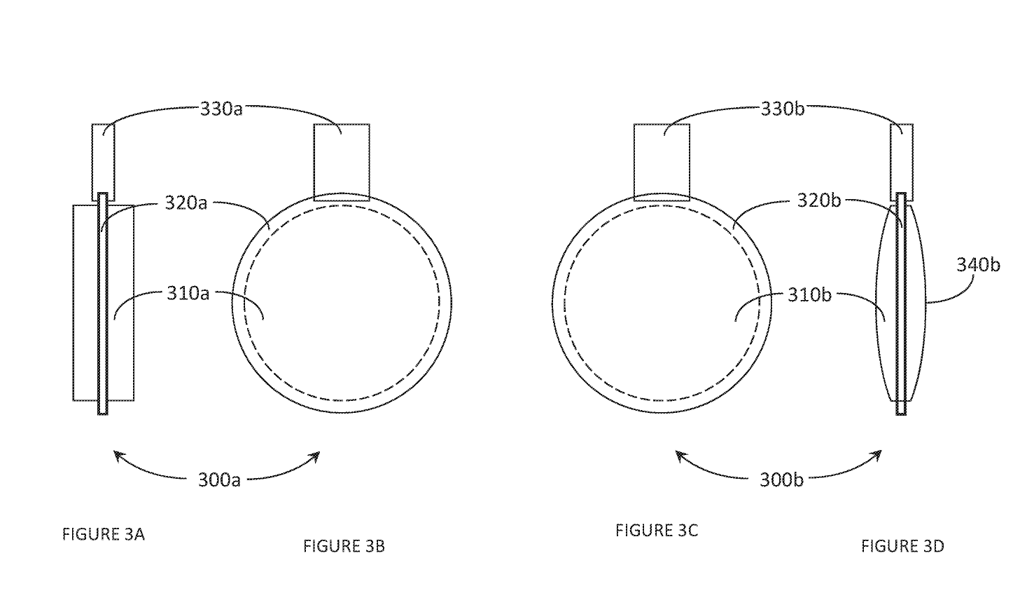

FIG. 3A is a side elevational view of an eyeglass lens blank 300a in accordance with the present systems, devices, and methods. FIG. 3B is a front elevational view of the eyeglass lens blank 300a of FIG. 3A. Eyeglass lens blank 300a is similar in some respects to eyeglass lens blank 200a. Eyeglass lens blank 300a is comprised of a single continuous piece of lens material. Eyeglass lens blank 300a is comprised of provisional optical element region 310a and grip tab region 320a. The grip tab 320a may be integral, and even a unitary single piece construction, with the optical element region 310a. Provisional optical element region 310a has a periphery and a size greater than an eyeglass lens in all dimensions.

Grip tab region 320a is positioned at the periphery of optical element region 310a. While shown as a rim extending completely around or symmetrically surrounding the periphery of the optical element region 310a, in some implementations the grip tab region 320a may extend only partially around or only partially surrounding the periphery of the optical element region 310a, for instance circumscribing one arc or two or more arcs. Grip tab region 320a extends beyond the periphery of provisional optical element region 310a. Grip tab region 320a is sized and dimensioned to interface with clip 330a. Grip tab region 320a is comprised of sacrificial lens material. All sacrificial lens material is removed from eyeglass lens blank 300a when eyeglass lens blank 300a is processed to produce an eyeglass lens. Clip 330a may be physically coupled to grip tab region 320a, in which case eyeglass lens blank 300a may be processed by supporting and maneuvering eyeglass lens blank 300a via clip 330a.

FIG. 3C is a side elevational view of a provisional lens structure 300b in accordance with the present systems, devices, and methods. FIG. 3D is a front elevational view of the provisional lens structure 300b of FIG. 3C. Provisional lens structure 300b is similar in some respects to eyeglass lens blank 200a. Provisional lens structure 300b is comprised of a single continuous piece of lens material. Provisional lens structure 300b is comprised of optical element region 310b and grip tab region 320b. The grip tab 320b may be integral, and even a unitary single piece construction, with the optical element region 310b. Optical element region 310b has a periphery and a size greater than an eyeglass lens in at least two dimensions. Provisional lens structure 300b is larger than an eyeglass lens in at least two dimensions and provisional lens structure 300b is the same size as an eyeglass lens in a third dimension; the third dimension is parallel with the optical axis of optical element region 310b.

Grip tab region 320b is positioned at the periphery of optical element region 310b. While shown as a rim extending completely around or symmetrically surrounding the periphery of the optical element region 310b, in some implementations the grip tab region 320b may extend only partially around or only partially surrounding the periphery of the optical element region 310b, for instance circumscribing one arc or two or more arcs. Grip tab region 320b extends beyond the periphery of provisional optical element region 310b. Grip tab region 320b is sized and dimensioned to interface with clip 330b. Grip tab region 320b is comprised of sacrificial lens material. All sacrificial lens material is removed from provisional lens structure 300b when provisional lens structure 300b is processed to produce an eyeglass lens. Clip 330b may be physically coupled to grip tab region 320b, in which case eyeglass lens blank 300b may be processed by supporting and maneuvering eyeglass lens blank 300b via clip 330b.

Optical element region 310b may include a lens, where the lens has a refractive power chosen from a range of −20 to +20 diopters. Optical element region 310b may include coating layer 340b, where coating layer 340b is located on one or more surfaces of optical element region 310b. If present, coating layer 340b is comprised of one or more coatings. Non-exclusive examples of coatings that may comprise coating layer 340b include hard coats (to at least reduce scratching of the eyeglass lens), anti-reflective (AR) coatings, antistatic coatings, anti-smudge coatings, and tint coatings.

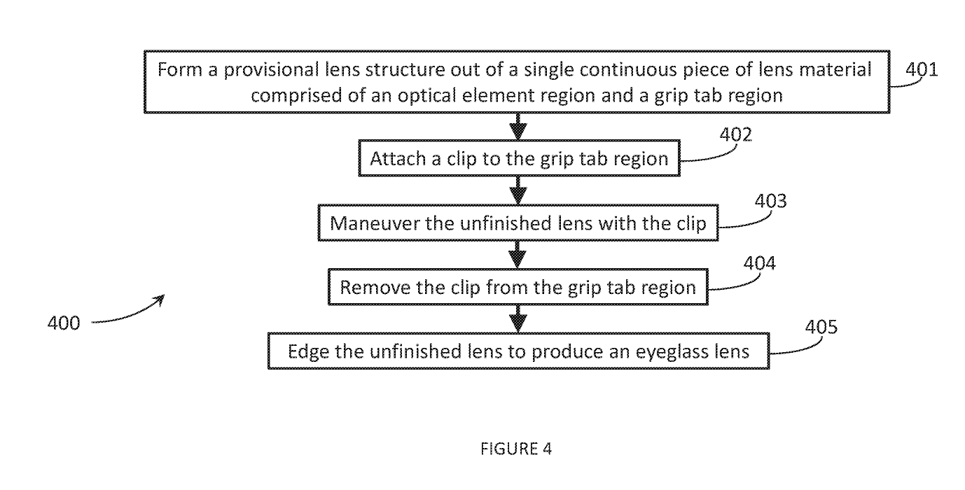

FIG. 4 is a flow diagram showing a method 400 of fabricating an eyeglass lens in accordance with the present systems, devices, and methods. Method 400 includes five acts 401, 402, 403, 404, and 405 though those of skill in the art will appreciate that in alternative embodiments certain acts may be omitted and/or additional acts may be added. Those of skill in the art will also appreciate that the illustrated order of the acts is shown for exemplary purposes only and may change in alternative embodiments.

As an illustrative example of the physical elements of method 400, analogous structures from FIG. 3 are called out in parentheses throughout the description of acts 401, 402, 403, 404, and 405.

At 401, a provisional lens structure (300b) is formed, where forming of the provisional lens structure (300b) includes shaping a single continuous piece of lens material to define an optical element region (310b) having a periphery and a grip tab region (320b) positioned at the periphery of the lens. The grip tab region (320b) is sized and dimensioned to interface with a clip (330b). Non-exclusive examples of forming a provisional lens structure (300b) include casting a provisional lens structure (300b) with liquid resin and milling an eyeglass lens blank (300a) with a computer numeric control (CNC) mill.

Milling an eyeglass lens blank (300a) with a CNC mill includes mounting an eyeglass lens blank (300a) in a CNC mill chuck, removing a portion of the eyeglass lens blank (300a) to produce a provisional lens structure (300b), and dis-mounting the provisional lens structure (300b) from the CNC mill chuck. Throughout this specification and the appended claims, the term “CNC mill chuck” generally refers to the component of a CNC mill which physically couples a workpiece (e.g., an eyeglass lens blank) to the CNC mill. Removing a portion of the eyeglass lens blank (300a) includes removing a portion of the eyeglass lens blank (300a) by cutting, grinding, and lapping the eyeglass lens blank.

Cutting a provisional lens structure (300b) includes pressing a solid hard tool against a provisional lens structure (300b) to remove a portion of the provisional lens structure (300b). Grinding a provisional lens structure (300b) includes pressing an abrasive-covered tool against a provisional lens structure (300b), where the abrasive is physically coupled to the tool, to remove a portion of the provisional lens (300b). Lapping a provisional lens structure (300b) includes pressing a solid soft tool against a provisional lens structure (300b) while an abrasive-containing slurry passes between the soft tool and the provisional lens structure (300b); the passage of the abrasive-containing slurry removes a portion of the provisional lens structure (300b). The abrasive-containing slurry may be passed between the soft tool and the provisional lens structure by moving the soft tool relative to the provisional lens structure.

Forming a provisional lens structure (300b) may include forming a provisional lens structure (300b) with an optical element region (310b) in the shape of a lens, where the lens has a refractive power chosen from a range of −20 to +20 diopters. Throughout this specification and the appended claims, the term “diopter” refers to the focal length of a lens in units of reciprocal meters.

At 402, a clip (330b) is attached to the grip tab region (320b) of the provisional lens structure (300b). Attaching a clip (330b) to the grip tab region (320b) of the provisional lens structure (300b) includes adhering the clip (330b) to the grip tab region (320b) of the provisional lens structure (300b) with adhesive, welding the clip (330b) to the grip tab region (320b) of the provisional lens structure (300b), fastening the clip (330b) to the grip tab region (320b) of the provisional lens structure (300b) with a mechanical locking feature, and fastening the clip (330b) to the grip tab region (320b) with fastening hardware. Non-exclusive examples of adhesives include cyanoacrylate adhesive, two-part epoxy, glue, and photo-cured (e.g., UV cured) adhesive, hot melt glue, thermosetting adhesive, pressure sensitive adhesive, acrylic, polyurethane, or polyimide based adhesives. Non-exclusive examples of welding methods include thermal welding and solvent welding. Non-exclusive examples of mechanical locking features include locking tabs, tongue-and-groove, dovetail, hook-and-eye, and bayonet fittings. Non-exclusive examples of fastening hardware include clamps, screws, nails, bolts, rivets, and locking bolts.

At 403, the provisional lens structure (300b) is processed to create the eyeglass or finished lens. Processing the provisional lens structure (300b) includes supporting and maneuvering the provisional lens structure (300b) via the clip (330b). Supporting and maneuvering the provisional lens structure (300b) via the clip (330b) includes at least one maneuver selected from a group consisting of: raising the provisional lens structure (300b) via the clip (330b), lowering the provisional lens structure (300b) via the clip (330b), rotating the provisional lens structure (300b) via the clip (330b), and displacing the provisional lens structure (300b) via the clip (330b), or otherwise positioning and/or orienting the provisional lens structure (300b) via the clip (330b). Displacing the provisional lens structure (300b) via the clip (330b) includes mounting the provisional lens structure (300b) in a bracket via the clip (330b) and dis-mounting the provisional lens structure (300b) from a bracket via the clip (330b). Mounting the provisional lens structure (300b) in a bracket includes physically coupling the provisional lens structure (300b) to the bracket. Non-exclusive examples of physical coupling include welding, adhering, interference fitting, holding in compression via exposed prongs, and mechanical locking.

The optical element region (310b) of the provisional lens structure (300b) is physically coupled to the clip (330b) via the grip tab region (320b), thus maneuvering the clip (330b) also results in maneuvering the optical element region (310b). Maneuvering the provisional lens structure (300b) via the clip (330b) is advantageous because, for example, misalignment of the clip (330b) during mounting of the clip (330b) into a bracket will only cause scratches to the clip (330b), and will not cause damage to the provisional lens structure (300b). The clip (330b) may be grasped firmly by a mechanical arm with no risk of causing damage to the optical element region (310b) by doing so, and with reduced risk of dropping the provisional lens structure (300b) when the provisional lens structure (300b) is transported from one place to another.

Processing the provisional lens structure (300b) typically includes applying at least one coating to the provisional lens structure (300b) while supporting and maneuvering the provisional lens structure (300b) via the clip (330b). Non-exclusive examples of coatings which may be applied during processing include hard coats (to at least reduce scratching of the eyeglass lens), anti-reflective (AR) coatings, antistatic coatings, anti-smudge coatings, and tint coatings.

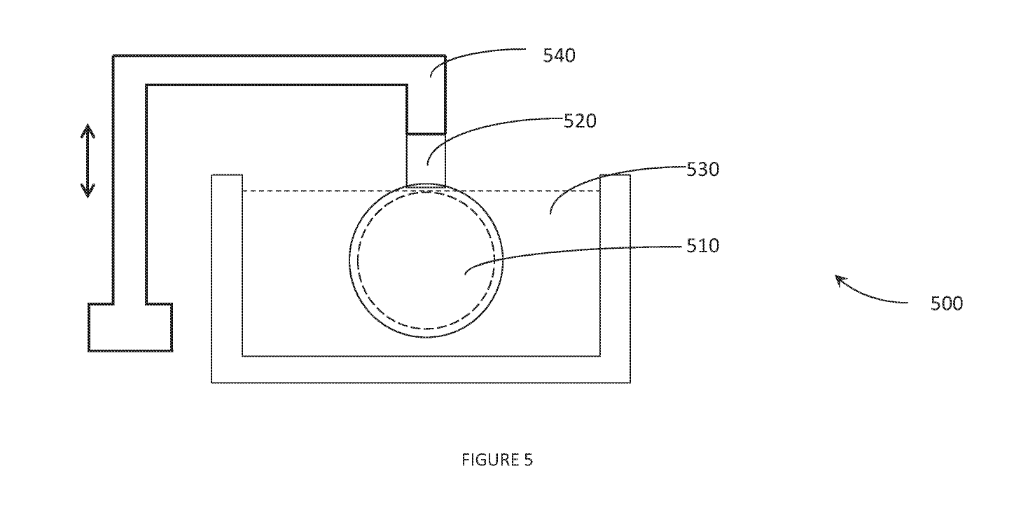

FIG. 5 shows a cross-sectional view of provisional lens structure dip-coating assembly 500 in accordance with the present systems, devices, and methods. Hard coats are typically applied by dip coating. Provisional lens structure dip coating assembly 500 comprises provisional lens structure 510, clip 520, liquid coating material 430 and mechanical arm 540. Provisional lens structure 510 is similar in some respects to provisional lens structure 300b. Provisional lens structure 510 is physically coupled to clip 520. Clip 520 is physically coupled to mechanical arm 540. Mechanical arm 540 may move up or down at a controlled rate, thereby raising and lowering, respectively, provisional lens structure 510 via clip 520 consistent with act 403 of method 400. Provisional lens structure 510 may be lowered into liquid coating material 530 by mechanical arm 540 via clip 520. The left, right, and bottom walls comprising the sides and bottom of the vessel containing liquid coating material 530 are visible in FIG. 5, however the front and back walls of the vessel containing liquid coating material 530 cannot be seen due to the cross-sectional view of FIG. 5.

Lowering provisional lens structure 510 into liquid coating material 530 causes provisional lens structure 510 to be covered by liquid coating material 530. Raising provisional lens structure 510 out of liquid coating material 530 at a controlled rate causes a layer of liquid coating material 530 with well-controlled thickness to remain on the surface of provisional lens structure 510, any excess liquid coating material 530 flows down and off provisional lens structure 510. Liquid coating material 530 is then cured to form a coating.

Dip coating is able to produce a layer of liquid coating material 530 with well-controlled thickness because liquid coating material 530 flows off provisional lens structure 510 at a constant rate across the entire surface of provisional lens structure 510. Lowering provisional lens structure 510 into liquid coating material 530 via clip 520 allows the entire optical element region of provisional lens structure 510 to be submerged in the liquid coating material without requiring any portion of clip 520 to be submerged in the liquid coating material. Clip 520 may then be re-used without the need for an additional cleaning process to remove liquid coating material 530 from clip 520.

Raising provisional lens structure 510 out of liquid coating material 530 via clip 520 allows liquid coating material 530 to flow off provisional lens structure 510 without encountering obstacles that would disrupt the flow of liquid coating material 530 off provisional lens structure 510. A layer of liquid coating material 530 of constant thickness may therefore be applied across the entire surface of the optical element region. Non-exclusive examples of obstacles include contact points from traditional clips and protruding components from traditional clips. If the flow of liquid coating material 530 is disrupted by an obstacle the liquid coating material that remains on the surface of provisional lens structure 510 will be of an uneven thickness, causing a visible defect in the coating layer and causing the lens to be unusable.

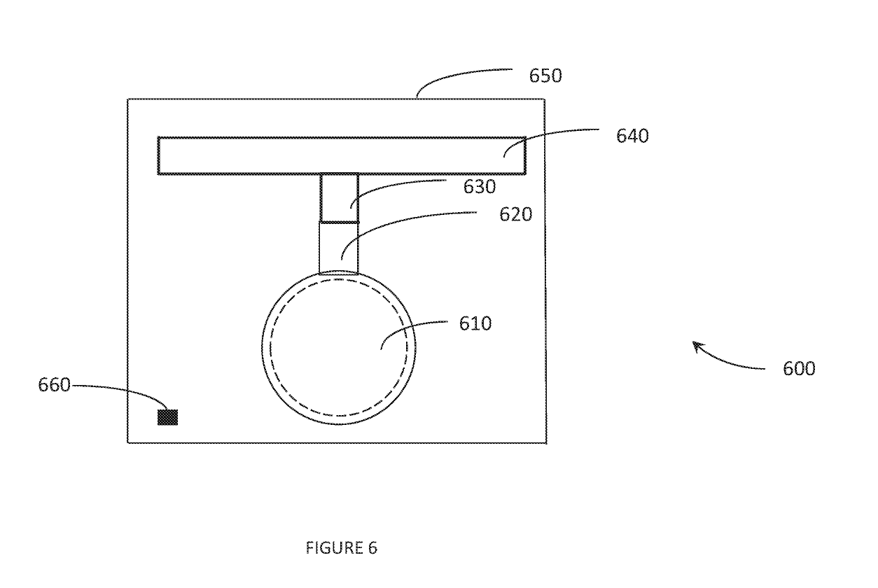

FIG. 6 shows a cross-sectional view of provisional lens structure AR-coating assembly 600 in accordance with the present systems, devices, and methods. Provisional lens structure AR-coating assembly 600 comprises provisional lens structure 610, clip 620, bracket 630, calotte 640, vacuum chamber 650, and AR material 660. Provisional lens structure 610 is similar in some respects to provisional lens structure 300b. Provisional lens structure 610 is physically coupled to clip 620; clip 620 is physically coupled to bracket 630; bracket 630 is physically coupled to calotte 640. Bracket 630 supports provisional lens structure 610 via clip 620, consistent with act 403 of method 400. Only a single bracket is shown in FIG. 6, however a person skilled in the art will appreciate that a calotte may include greater than 1 bracket, and that multiple provisional lens structures may be physically coupled to a corresponding bracket via a corresponding clip.

Air may be removed from vacuum chamber 650, rendering vacuum chamber 650 empty of air, at a highly reduced air pressure, where a highly reduced air pressure includes a pressure less than 1% of atmospheric pressure at sea level. AR material 660 may be heated, causing a first amount of AR material 660 to evaporate and travel across the space between AR material 660 and provisional lens structure 610. Once the first amount of AR material 660 reaches provisional lens structure 610, the first amount of AR material 660 is deposited as a coating on a first surface of provisional lens structure 610. Provisional lens structure 610 may be rotated by clip 620 to expose a second surface of provisional lens structure 610 to AR material 660, and a second amount of AR material 660 may be similarly deposited on the second surface of provisional lens structure 610.

Provisional lens structure 610 may be rotated inside vacuum chamber 650 while the chamber empty of air if provisional lens structure 610 is physically coupled to 640 calotte by a rotating bracket, i.e. bracket 630 is capable of rotation. Non-exclusive examples of methods by which bracket 630 may be rotated include mechanical gear assemblies and magnetic coupling. If bracket 630 is incapable of rotation then, prior to depositing the second amount of AR material 660 on the second surface of provisional lens structure 610, vacuum chamber 650 may be filled with air, and provisional lens structure 610 may be removed from the vacuum chamber by the calotte. Clip 630 may then be physically de-coupled from bracket 640, provisional lens structure 610 may be rotated, and clip 630 may be physically coupled to bracket 630. Provisional lens structure may then be placed inside vacuum chamber 650 by calotte 640. Air may be removed from vacuum chamber 650 prior to applying the second amount of AR material 660 on a second surface of provisional lens structure 610.

Applying an AR coating by supporting and maneuvering provisional lens structure 610 via clip 620 is advantageous because the risk of damaging the optical element region of provisional lens structure 610 is reduced by avoiding physical contact between the optical element region and calotte 640. Rotating provisional lens structure 610 while vacuum chamber 650 is empty of air is advantageous because the time needed to apply an AR coating to both sides of provisional lens structure 610 is reduced.

Returning to FIG. 4, at 404 the clip (330b) is removed from the grip tab region (320b). Non-exclusive examples of removing the clip (330b) from the grip tab region (320b) include opening a hinged joint on the clip (330b), applying a solvent to dissolve adhesive physically coupling the clip (330b) to the grip tab region (320b), heating an adhesive physically coupling the clip (330b) to the grip tab region (320b), cutting the grip tab region (320b), abrading the grip tab region (320b), and applying sufficient physical force to break the grip tab region (320b). Removing the grip tab region (320b) may include removing the grip tab region (320b) by mounting the provisional lens structure in the chuck of a CNC mill, removing the clip by the CNC mill, and dis-mounting the provisional lens structure from the chuck of a CNC mill.

At 405, the provisional lens structure (300b) is edged to produce an eyeglass lens. Edging the provisional lens structure (300b) includes removing material from the provisional lens structure (300b). The portion of the provisional lens structure (300b) that remains after edging (i.e., the portion of the provisional lens structure (300b) not removed) has the general shape and appearance of an eyeglass lens and may be physically coupled to an eyeglass lens frame. The provisional lens structure (300b) may be shaped by mounting the provisional lens structure (300b) in the chuck of a CNC mill, removing the grip tab region (320b) by the CNC mill, removing a portion of the optical element region (310b) by the CNC mill to produce an eyeglass lens, and dis-mounting the eyeglass lens from the chuck of the CNC mill. If removing the clip (330b) from the grip tab region (320b) is performed by a CNC mill, then removing the clip (330b) from the grip tab region (320b) and edging the provisional lens structure (300b) may be performed simultaneously.

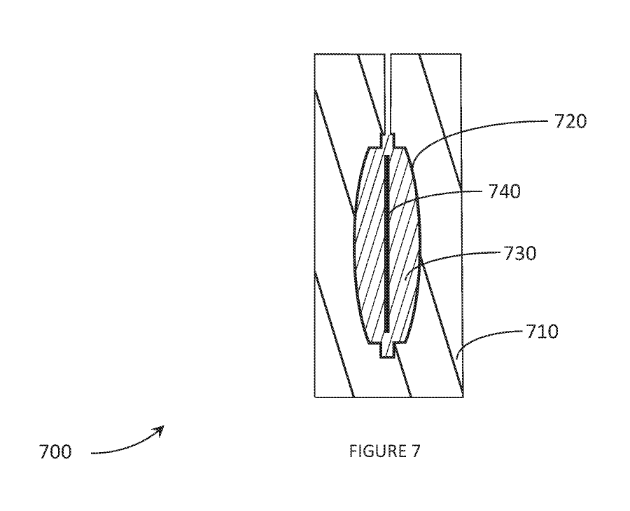

FIG. 7 shows a cross-sectional view of provisional lens structure forming mold 700 in accordance with the present systems, devices, and methods. Provisional lens structure forming mold 700 is comprised of mold 710, and internal cavity 720. Internal cavity 620 is of a shape consistent with the shape of a provisional lens structure with a grip tab region. Internal cavity 720 may be filled with resin 730, in which case internal cavity 720 will impart the shape of a provisional lens structure with a grip tab region onto resin 730. Curing of resin 730 will cause resin 730 to retain the shape of a provisional lens structure with a grip tab region. Filling internal cavity 720 with resin 730 and subsequently curing resin 730 is consistent with act 401 of method 400.

Diffractive element 740 may be mounted in internal cavity 720 prior to filling the mold with liquid resin. Non-exclusive examples of diffractive elements include a hologram, a holographic optical element, a volume diffraction grating, a surface relief diffraction grating, a transmission grating, or a reflection grating. The diffractive element may include a diffractive element physically coupled to a protective layer. In some implementations, diffractive element 740 may be carried on or by a waveguide or lightguide structure. If diffractive element 740 is a hologram, diffractive element 740 may comprise photopolymer material. If diffractive element 740 is a hologram, diffractive element 740 may comprise a wavelength multiplexed hologram. A wavelength multiplexed hologram comprises at least two wavelength-specific holograms, wherein each wavelength-specific hologram possesses a respective playback wavelength. A wavelength multiplexed hologram may include a red hologram, a green hologram, and a blue hologram.

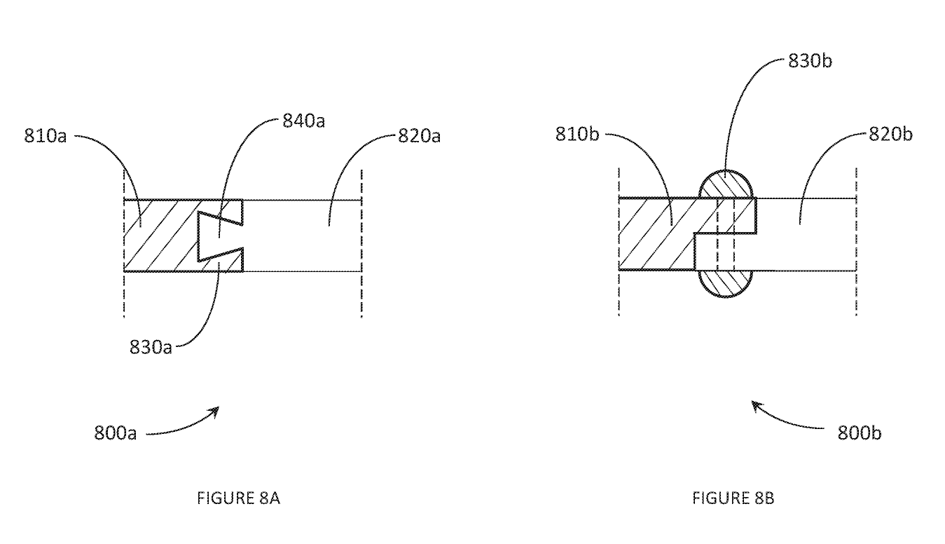

FIG. 8A shows mechanically locked assembly 800a in accordance with the present systems, devices, and methods. Mechanically locked assembly 800a comprises first component 810a, second component 820a, first mechanical locking feature sub-component 830a, and second mechanical locking feature sub-component 840a. Non-exclusive examples of components comprising first component 810a include a grip tab region, a clip, or a bracket. Non-exclusive examples of components comprising second component 820a include a grip tab region, a clip, or a bracket. First mechanical locking feature sub-component 830a and second mechanical locking feature sub-component 840a are each of a shape such that first mechanical locking feature sub-component 830a and second mechanical locking feature sub-component 840a may be fitted together.

When first mechanical locking feature sub-component 830a and second mechanical locking feature sub-component 840a are fitted together first component 810a and second component 820a will not physically de-couple when force is applied to mechanically locked assembly 800a in at least one direction. When first mechanical locking feature sub-component 830a and second mechanical locking feature sub-component 840a are fitted together first component 810a and second component 820a form a mechanical locking feature. Non-exclusive examples of mechanical locking features include locking tabs, tongue-and-groove, dovetail, hook-and-eye, and bayonet fittings; an example of a dovetail mechanical locking feature is shown in FIG. 8A.

FIG. 8B shows mechanically fastened assembly 800b in accordance with the present systems, devices, and methods. Mechanically fastened assembly 800b comprises first component 810b, second component 820b, and fastening hardware 830b. Non-exclusive examples of components comprising first component 810b include a grip tab region, a clip, or a bracket. Non-exclusive examples of components comprising second component 820b include a grip tab region, a clip, or a bracket. First component 810b and second component 820b are fastened together by fastening hardware 830b. When first component 810b and second component 820b are fastened together, first component 810a and second component 820a will not physically de-couple when force is applied to mechanically fastened assembly 800b in at least one direction. Fastening hardware 830b may pass through first component 810b and second component 820b; fastening hardware 830b may pass around first component 810b and second component 820b. Non-exclusive examples of fastening hardware include clamps, screws, nails, bolts, rivets, and locking bolts; an example of a rivet is shown in FIG. 8B.

A person of skill in the art will appreciate that the various embodiments for manufacturing an eyeglass lens described herein may be applied in non-WHUD applications. For example, the present systems, devices, and methods may be applied in non-wearable heads-up displays and/or in other applications that may or may not include a visible display.

In some implementations, one or more optical fiber(s) may be used to guide light signals along some of the paths illustrated herein.

The WHUDs described herein may include one or more sensor(s) (e.g., microphone, camera, thermometer, compass, altimeter, and/or others) for collecting data from the user's environment. For example, one or more camera(s) may be used to provide feedback to the processor of the WHUD and influence where on the display(s) any given image should be displayed.

The WHUDs described herein may include one or more on-board power sources (e.g., one or more battery(ies)), a wireless transceiver for sending/receiving wireless communications, and/or a tethered connector port for coupling to a computer and/or charging the one or more on-board power source(s).

The WHUDs described herein may receive and respond to commands from the user in one or more of a variety of ways, including without limitation: voice commands through a microphone; touch commands through buttons, switches, or a touch sensitive surface; and/or gesture-based commands through gesture detection systems as described in, for example, US Non-Provisional patent application Ser. No. 14/155,087, U.S. Non-Provisional patent application Ser. No. 14/155,107, PCT Patent Application PCT/US2014/057029, and/or U.S. Provisional Patent Application Ser. No. 62/236,060, all of which are incorporated by reference herein in their entirety.

Throughout this specification and the appended claims the term “communicative” as in “communicative pathway,” “communicative coupling,” and in variants such as “communicatively coupled,” is generally used to refer to any engineered arrangement for transferring and/or exchanging information. Exemplary communicative pathways include, but are not limited to, electrically conductive pathways (e.g., electrically conductive wires, electrically conductive traces), magnetic pathways (e.g., magnetic media), and/or optical pathways (e.g., optical fiber), and exemplary communicative couplings include, but are not limited to, electrical couplings, magnetic couplings, and/or optical couplings.

Throughout this specification and the appended claims, infinitive verb forms are often used. Examples include, without limitation: “to detect,” “to provide,” “to transmit,” “to communicate,” “to process,” “to route,” and the like. Unless the specific context requires otherwise, such infinitive verb forms are used in an open, inclusive sense, that is as “to, at least, detect,” to, at least, provide,” “to, at least, transmit,” and so on.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other portable and/or wearable electronic devices, not necessarily the exemplary wearable electronic devices generally described above.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet which are owned by Thalmic Labs Inc., including but not limited to: US Patent Application Publication No. US 2017-0068095 A1; US Patent Application Publication No. US 2017-0212290 A1; U.S. Provisional Patent Application Ser. No. 62/482,062; U.S. Provisional Patent Application Ser. No. 62/534,099, U.S. patent application Ser. No. 15/946,549, U.S. patent application Ser. No. 15/946,557, U.S. patent application Ser. No. 15/946,562, U.S. patent application Ser. No. 15/946,565, U.S. patent application Ser. No. 15/946,569, U.S. Patent Application Ser. No. 62/565,677, and/or U.S. Patent Application Ser. No. 62/680,449, are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A provisional lens structure for processing into a finished lens, the provisional lens structure comprising:
a single continuous piece of lens material, the single continuous piece of lens material including:
an optical element region having a periphery, where the optical element region has a size greater than an eyeglass lens in at least two dimensions; and
a grip tab region comprised of sacrificial lens material, wherein the grip tab region is positioned at the periphery of the optical element region, and where the grip tab region sized and dimensioned to interface with a clip.

2. The provisional lens structure of claim 1 wherein the grip tab region extends outward from the optical element region in a direction perpendicular to a principal axis of the optical element region.

3. The provisional lens structure of claim 1 wherein the grip tab region extends outward from the optical element region symmetrically in all directions perpendicular to the principal axis of the optical element region.

4. The provisional lens structure of claim 1 wherein the grip tab region extends outward from the optical element region asymmetrically in at least one direction perpendicular to the principal axis of the optical element region.

5. The provisional lens structure of claim 1 wherein the optical element region includes a diffractive element embedded within an inner volume thereof.

6. The eyeglass lens blank of claim 1 wherein the diffractive element comprises photopolymer.

7. The eyeglass lens blank of claim 1 wherein the diffractive element comprises a hologram.

8. The eyeglass lens blank of claim 7 wherein the hologram comprises a wavelength-multiplexed hologram.

9. The provisional lens structure of claim 1 wherein the optical element region includes a lens, where the lens has a refractive power chosen from a range of −20 to +20 diopters.
